(19) United States
(12) Patent Application Publication
(10) Pub. No.: US 2012/0133999 A1
(43) Pub. Date: May 31, 2012

(54) METHOD OF READING IMAGE AND THE IMAGE READING DEVICE

(75) Inventors: Hsien-Chi Lin, Taichung (TW); Kung-Hsin Teng, Taichung (TW); Chih-Wen Wang, Taichung (TW); Ming-Fu Hsu, Taichung (TW)

(73) Assignee: ASIA OPTICAL CO., INC., Taichung (TW)

(21) Appl. No.: 13/237,077

(22) Filed: Sep. 20, 2011

(30) Foreign Application Priority Data
Nov. 26, 2010 (TW) 099141094

(51) Int. Cl. H04N 1/46

(52) U.S. Cl. 358/509

(57) ABSTRACT

A method and device of reading images includes a light source emitting at least three difference color lights. The light source emits color lights to an object in a predetermined order and frequency. The object reflects the color lights to three monochromatic sensor rows through a lens row to directly image the color light on the sensor rows. The light source changes the color light emitting to the object when the light source, the sensor rows and the lens row are moved for a predetermined, usually is a width of a pixel, to combine a color image without chromatic aberration.

### BACKGROUND OF THE INVENTION

1. Field of the Invention

The present invention relates generally to image processing, and more particularly to a method of reading a color image or a monochromatic image, and an image reading device utilizing the method.

2. Description of the Related Art

U.S. Pat. No. 7,449,666 taught an image reading device. As shown in FIG. 4 and FIG. 5, the image reading device 70 includes a light source 71, a lens array 73, and a sensor array 75. The light source 71 includes a red light emitting element, a blue light emitting element and a green light emitting element, the lens array 73 includes a plurality of rod lenses, and the sensor array 75 may sense monochromatic images. The light source 71, the lens array 73 and the sensor array 75 are moved synchronously in a predetermined direction to emit red light 71R, green light 71G, and blue light 71B of the light source 71 to an object 99, and then the lens array 73 reflect the rays to the sensor array 75 that the sensor array 75 may generate a signal according to a distribution of the rays.

The sensor array 75 of the image reading device 70 only has a row that the light source 71 has to switch the red light 71R, green light 71G, and blue light 71B in sequence when the light source 71, the lens array 73 and the sensor array 75 are moved synchronously within a pixel. As a result, red light, green light, and blue light only take one-third in each pixel of the object 99 sensed by the sensor array 75, and there will be two-third chromatic aberration in each pixel.

In the prior art of U.S. Pat. No. 7,449,666, it taught a conventional image reading device 80, as shown in FIG. 6 and FIG. 7, including a white light source 81 emitting white light to an object 99, a lens array 83 reflecting the light to three rows of a sensor array 85R, 85G, 85B. The row 85R of the sensor array has a red light filter 86R, the row 85G has a green light filter 86G, and the row 85B has a blue light filter 86B to sense red light images, green light images, and blue light images respectively. This kind of image reading device 80 is provided with three rows 85R, 85G, 85B of monochromatic image sensors that it may sense the image of the object on three rows of pixel in the same time.

As shown in FIG. 7, when the white light source 81, the lens array 83, and the sensor array 85R, 85G, 85B are moved in a distance of a width of a pixel, the sensor array 85R, 85G, 85B may senses images of the object 99 on three pixel rows of different colors. When the white light source 81, the lens array 83, and the sensor array 85R, 85G, 85B start to move to the third row of pixel where the white light emits to the object 99, it may obtain a color image.

This conventional image reading device 80 doesn't have the chromatic aberration problem of the first image reading device 70. However, after the white light emits through the filters 86R, 86G, 86B, the filters 86R, 86G, 86B will cut off much power of the light that the sensor array 85R, 85G, 85B only senses few light. In order to speed up scanning, it has to increase the luminance of the light source that power problem and heat problem of the light source will be raised. Besides, the filters 86R, 86G, 86B will cost the device higher.

The image reading device 70 is provided with filters also, so it has the above drawbacks as well.

### SUMMARY OF THE INVENTION

The primary objective of the present invention is to provide a method of reading color image without chromatic aberration problem.

The secondary objective of the present invention is to provide an image reading device, which doesn't have chromatic aberration problem, and no filter is needed in the device to have a low cost and high speed of reading the image.

The third objective of the present invention is to provide a method of reading color image, which is fast in sensing image and needs a light source with lower luminance.

According to the objectives of the present invention, the present invention provides a method of reading a color image. The method includes the following steps:
A. Put an object at a predetermined place.
B. Provide a light source to emit a first color light to the object that the object reflects the first color light to at least three monochromatic sensor rows to be directly imaged on the sensor rows, and read signals of the sensor rows sensing the first color light.
C. Synchronously move the light source and the sensor rows in a predetermined direction;
D. Changing the color light emitted from the light source to the object from the first color light to a second color light that object reflects the second color light to the sensor rows to be directly imaged on the sensor rows, and read signals of the sensor rows sensing the second color light when the light source and the sensor rows are moved for a predetermined distance;
E. Change the color light emitted from the light source to the object from the second color light to a third color light that object reflects the third color light to the sensor rows to be directly imaged on the sensor rows, and read signals of the sensor rows sensing the third color light when the light source and the sensor rows are further moved for the predetermined distance;
F. Change the color light emitted from the light source to the object from the third color light to the first color light that object reflects the first color light to the sensor rows to be directly imaged on the sensor rows, and read signals of the sensor rows sensing the first color light when the light source and the sensor rows are further moved for the predetermined distance; and
G. Repeating the step D to the step F until all of signals of the image of the object are read.

The present invention further provides a method of reading a monochromatic image. The method includes the following steps:
A. Put an object at a predetermined place;
B. Provide a light source, which emit a plurality of color lights and the color lights are mixed into white light, to emit the white light to the object that the object reflects the white light to at least three monochromatic sensor rows to be directly imaged on the sensor rows, and read signals of the sensor rows sensing the white light;
C. Synchronously move the light source and the sensor rows in a predetermined direction; and
D. Repeat reading signals of the sensor rows sensing the white light every time when the light source and the sensor rows are moved for the predetermined distance until all of signals of the image of the object are read.

The present invention further provides an image reading device utilizing the above methods. The image reading device includes a light source emitting at least three difference color lights to the object that the object reflects the color lights; at least three monochromatic sensor rows; and at least a lens row provided between the light source and the sensor rows to directly image the color lights reflected by the object on the sensor rows.

### BRIEF DESCRIPTION OF THE DRAWINGS

FIG. 1 is a sketch diagram of a preferred embodiment of the present invention;

FIG. 2 is a sketch diagram of the steps to reading color image of the preferred embodiment of the present invention;

FIG. 3 is a sketch diagram of the steps to reading monochromatic image of the preferred embodiment of the present invention;

FIG. 4 is a sketch diagram of the conventional image reading device;

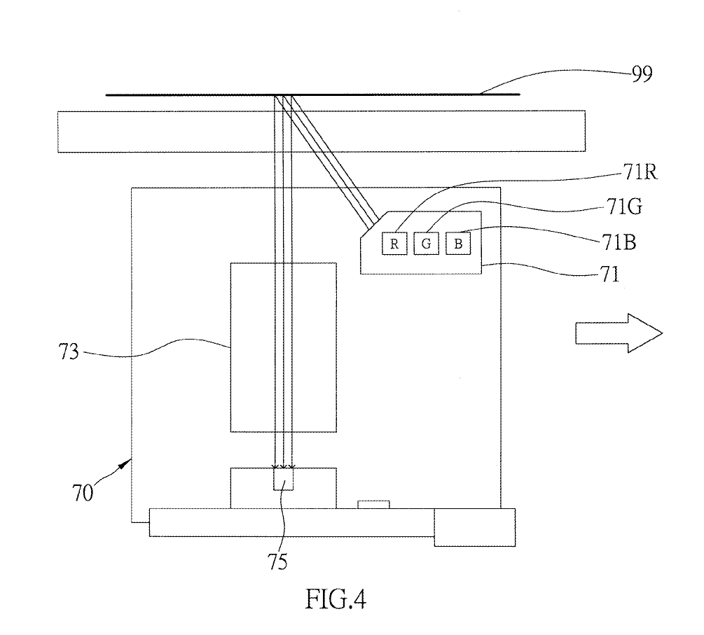

FIG. 5 is a sketch diagram of the steps to reading color image of the device shown in FIG. 4;

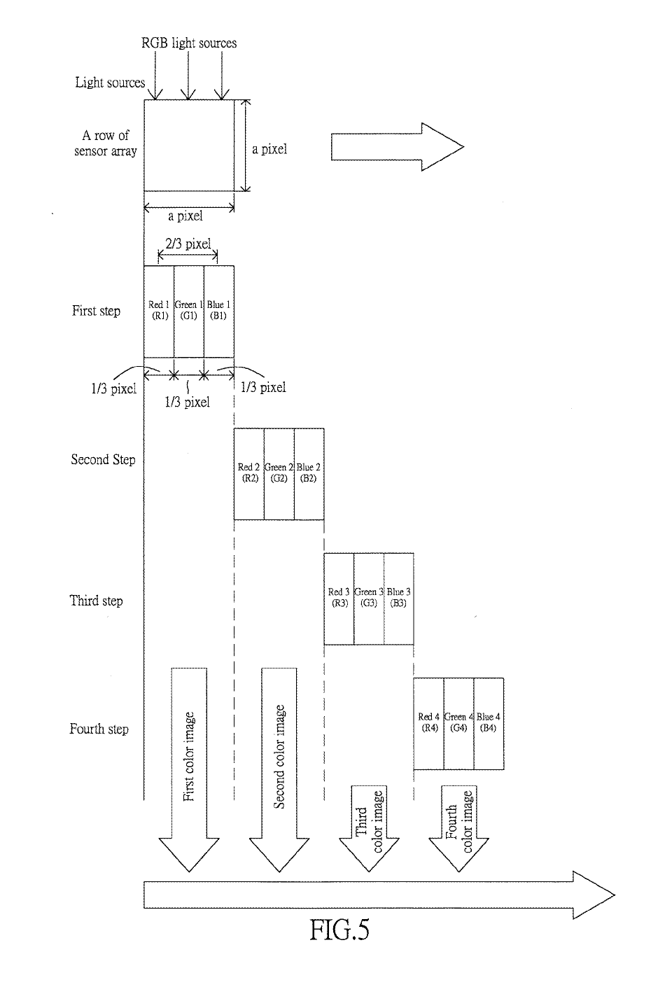

FIG. 6 is a sketch diagram of another conventional image reading device; and

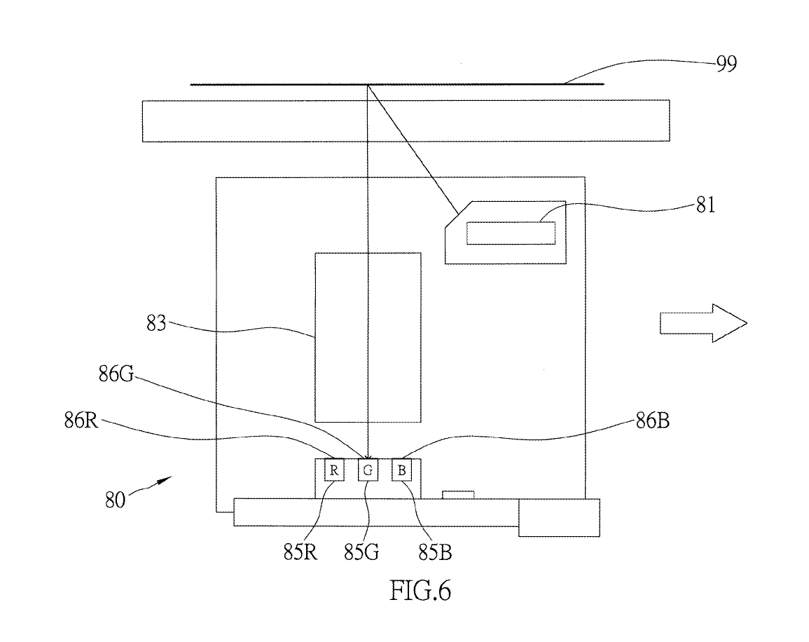

FIG. 7 is a sketch diagram of the steps to reading color image of the device shown in FIG. 6.

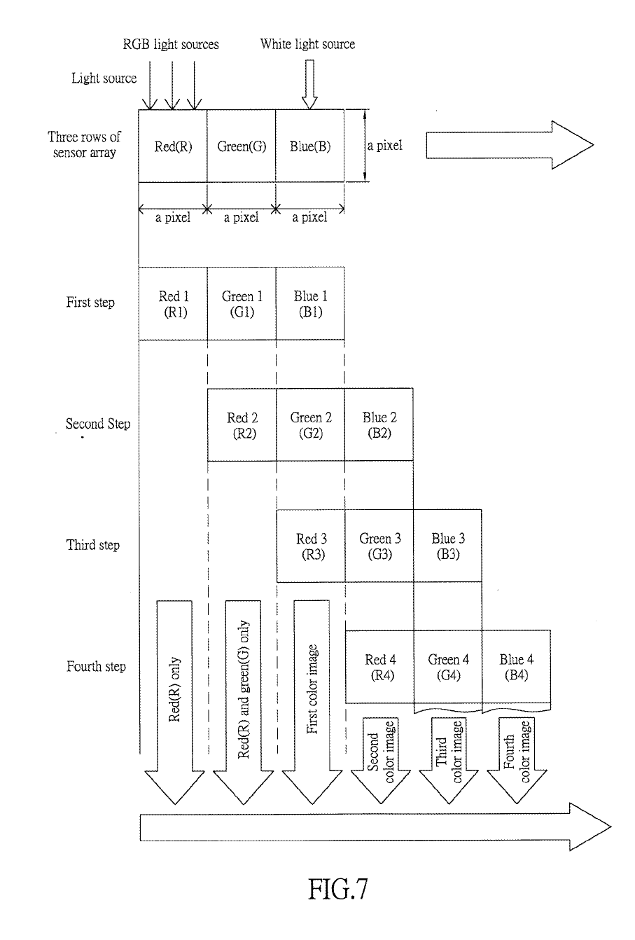

### DETAILED DESCRIPTION OF THE INVENTION

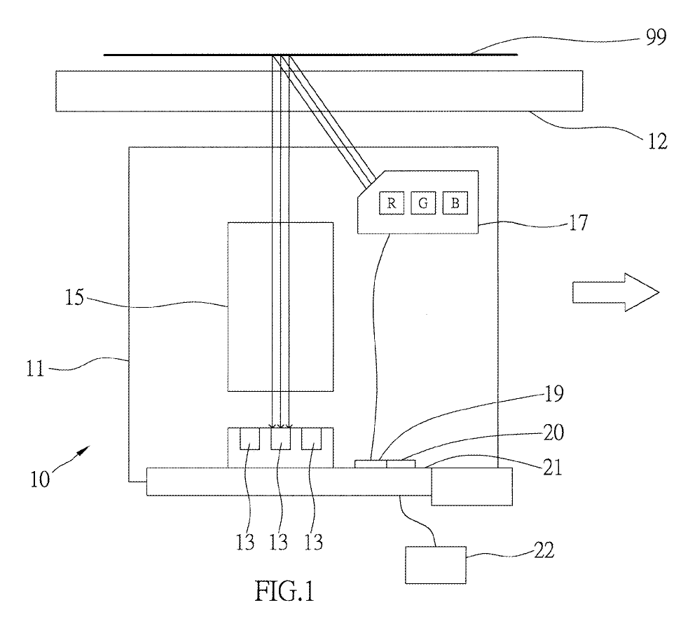

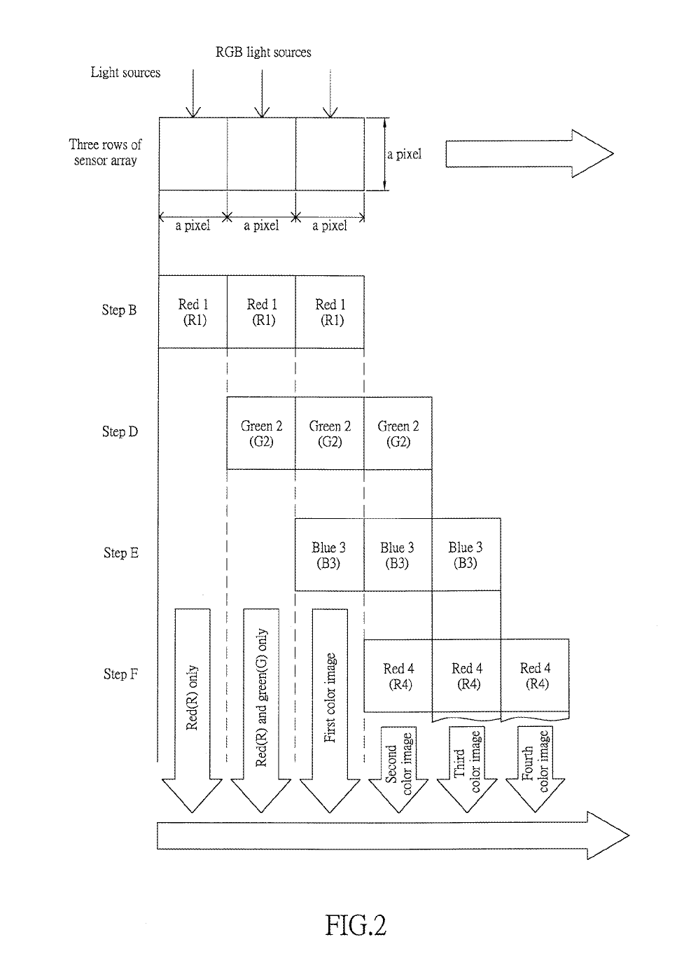

FIG. 1 and FIG. 2 show a method of reading color image of the preferred embodiment of the present invention and an image reading device 10. The method of the present invention may obtain a plane image of an object or a plane image of a predetermined view of a three-dimension object. The method and the device 10 of the present invention may be applied in scanner, printer, copier, fax machine, or other relative machines.

The method of the present invention includes the following steps:

Step A. Put an object 99 at a predetermined position:

The image reading device 10 provides a transparent board 12, on which the object 99 may be put. A side of the object 99 facing the board 12 will be scanned to obtain an image thereof. The board 12 may be a glass board, a plastic board, or other relative elements.

Step B. Provide a light source which emits at least three color lights to emit a first color light to the object 99, and after that, at least a part of the first light is reflected by the object 99 to be imaged on at least three monochromatic sensor rows, and then reading image signals of the monochromatic sensor rows.

The image reading device 10 is provided with a light source 17 at a side of the transparent board 12 opposite to the object 99. In the present embodiment, the light source 17 has a plurality of LEDs to emit three color lights. The light source 17 emits flat beams. The three color lights may be red light, green light, and blue light, or cyan light, magenta light, and yellow light, or other combinations of the color lights. In the present invention, the color lights of the light source 17 are red light, green light, and blue light, and the first color light is red light.

The image reading device 10 further has a control circuit 19, which is provided on a circuit board 21 and is electrically connected to the light source 17 to control the light source 17 to emit the color lights in what kind of sequence, frequency, and power. The circuit board 21 is provided at the side of the transparent board 12 having the light source 17.

The first color light emits to the transparent board 12 in a predetermined incidence angle, and emits to the object 99 on the other side of the transparent board 12. And then, the first color light is reflected by the object 99.

The image reading device 10 further is provided with at least three parallel monochromatic sensor rows 13 on the circuit board 21. In the present invention, there are three monochromatic sensor rows 13, and in practice, it may be provided with more than three monochromatic sensor rows for a better performance.

The image reading device 10 includes at least a rod lens row 15 at the side of the side of the transparent board 12 having the light source 17 and between the transparent board 12 and the sensor rows 13 to image the light reflected by the object 99 on the sensor rows 13. In the present invention, there only is a rod lens row 15, and in practice, it may be provided with two or more rod lens rows for a better performance.

There is a consistent relationship among the locations of the light source 17, the sensor rows 13, and the rod lens row 15. In the present invention, the light source 17, the circuit board 21, the sensor rows 13, and the rod lens row 15 are mounted on a substrate 11.

In the present step, the reflected part of the first color light is imaged on the sensor rows 13 directly without any filter. In other words, there is no filter between the sensor rows 13, and the rod lens row 15 to avoid the loss of the light power.

The image reading device 10 of the present invention further has a reading circuit 20 on the circuit board 21 to read image signals of the sensor rows 13 for the image.

Step C. Synchronously move the light source 17, the sensor rows 13, and the rod lens row 15 in a predetermined direction.

In the step C, the light source 17, the sensor rows 13, and the rod lens row 15 are moved in a constant speed. For this, the image reading device 10 is provide with a driving member 22 to move the light source 17, the sensor rows 13, and the rod lens row 15 synchronously in a constant speed and in a consistent direction. The driving member 22 may includes a motor and a transmission unit, such as shaft and gears. The driving member 22 is a well known mechanism in this art, so we do not describe the detail here.

Step D. Control the light source 17 to stop the first color light and emit a second color light when the light source 17, the sensor rows 13, and the rod lens row 15 are moved a predetermined distance. The second color light will be reflected by the object 99 also and is imaged on the sensor rows 13 directly, and then read the image signals generated by the sensor rows 13 because of the second color light.

In the present invention, the time to change the color light is controlled by the control circuit 17. The detail of the control is well known in this art, so we do not describe the detail here.

In the step D, the distance of the movement of the light source 17, the sensor rows 13, and the rod lens row 15 is width of a pixel. Take 600 dpi for example, the width of a pixel is about 0.04233 mm. Under different consideration, the distance may be a total width of two or more pixels.

In the present invention, the second color light is green light.

Step E. Control the light source 17 to stop the second color light and emit a third color light when the light source 17, the sensor rows 13, and the rod lens row 15 are moved another predetermined distance. The third color light will be reflected by the object 99 also and is imaged on the sensor rows 13 directly, and then read the image signals generated by the sensor rows 13 because of the third color light.

In the present invention, the third color light is blue light.

Step F. Control the light source 17 to stop the third color light and emit first color light again when the light source 17, the sensor rows 13, and the rod lens row 15 further are moved another predetermined distance. The first color light will be reflected by the object 99 also and is imaged on the sensor rows 13 directly, and then read the image signals generated by the sensor rows 13 because of the first color light.

Step G. Repeat the step B to step F until all of the image signals of the object 99 are read.

As shown in FIG. 2, in the steps from the step B to the step G, with the object 99 being imaged on the rod lens row 15, the sensor rows 13 sense three rows of pixels of the image of the object 99 in the same time.

In the step B, the sensor rows 13 sense a first row pixel, a second row pixel, and a third row pixel of the image of the object 99 in the same time by the red light.

In the step D, when the light source 17, the sensor rows 13, and the rod lens row 15 are moved for a width of a pixel, the light source 17 stops emitting red light and emits green light that the sensor rows 13 sense the second row pixel, the third row pixel, and a fourth row pixel of the image of the object 99 in the same time by the green light. At this moment, the sensor rows 13 have been read out the red and green images at the second row pixel and the third row pixel.

In the step E, when the light source 17, the sensor rows 13, and the rod lens row 15 are further moved for another width of a pixel, the light source 17 stops emitting green light and emits blue light that the sensor rows 13 sense the third row pixel, the fourth row pixel, and a fifth row pixel of the image of the object 99 in the same time by the blue light. At this moment, the sensor rows 13 have been read out the red, green, and blue images at the third row pixel to form a color image of the object 99 at the third row pixel.

From the step E, the color images of the object 99 obtained from the third row pixel are complete color images without chromatic aberration that the present invention will not have the problem of the first conventional device as described in the background.

The method of the present invention provides at least a part of the light reflected from the object 99 being directly imaged on the sensor rows 13 so that no filter is involved in the present invention. In other words, there is no filter in the image reading device 10 of the present invention between the sensor rows 13 and the rod lens row 15. That is, the entire power of light can be utilized for imaging.

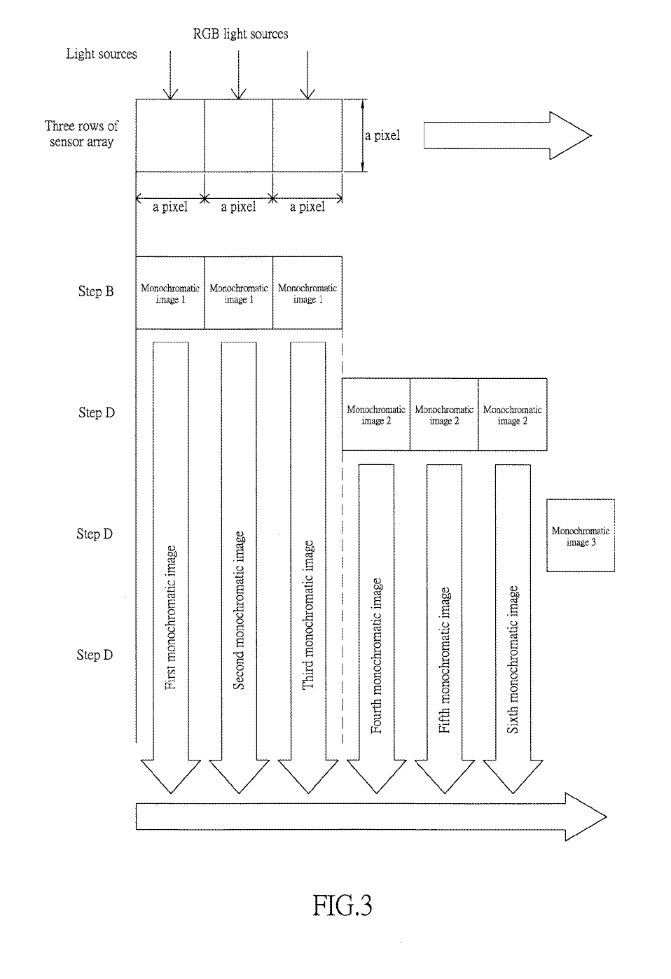

As shown in FIG. 3, the present invention provides another method of reading monochromatic images. The method of reading monochromatic images of the present invention may be achieved by the image reading device 10 of above also, so it may have to refer to FIG. 1 as well. The method of reading monochromatic images of the present invention includes the following steps:

Step A. Put an object 99 at a predetermined place.

Step B. Control the light source 17 to emit at least three lights with different colors to the object 99, wherein the color lights are mixed into white light. A part of the white light is reflected by the object 99 and is imaged on the at least three sensor rows 13, and then read the sensed signals.

In the present embodiment, the color lights are red light, green light, and blue light to be mixed into white light.

Step C. Synchronously move the light source 17 and the sensor rows 13 in a predetermined direction.

Step D. Read the sensed signals of the sensor rows 13 until all of the signals are read out when the light source 17 and the sensor rows 13 are moved for a predetermined distance.

The predetermined distance is identical to a total width of the rows of the pixels of the sensor rows 13. In the present invention, there are three sensor rows 13 that the distance is a total width of three pixels. The distance will be a total width of thirty pixels when there are thirty sensor rows.

In every step of moving the light source 17 and the sensor rows 13, each sensors of the sensor rows 13 senses monochromatic images at three different pixel rows that the speed of sensing is very fast and it only needs a light source with lower power.

The description above is a few preferred embodiments of the present invention. For example, the order of the light source emitting the color lights (red, green, and blue) may be changed. The equivalence of the present invention is still in the scope of claim construction of the present invention.

What is claimed is:

1. An image reading device for obtaining an image of an object, comprising:
a light source emitting at least three difference color lights to the object that the object reflects the color lights;
at least three monochromatic sensor rows; and
at least a lens row provided between the light source and the sensor rows to directly image the color lights reflected by the object on the sensor rows.

2. The image reading device as defined in claim 1, wherein the lens row includes at least a rod lens.

3. The image reading device as defined in claim 1, further comprising a control circuit electrically connected to the light source to control the light source to emit the color lights in a predetermined order.

4. The image reading device as defined in claim 3, wherein the control circuit further control a frequency of the light source emitting the color lights.

5. The image reading device as defined in claim 3, wherein the control circuit further control the light source emitting the color lights in the same time.

6. The image reading device as defined in claim 1, wherein the color lights emitted from the light source includes red light, green light, and blue light.

7. The image reading device as defined in claim 1, wherein the color lights emitted from the light source includes cyan light, magenta light, and yellow light.

8. The image reading device as defined in claim 1, further comprising a reading circuit electrically connected to the sensor rows to read signals of the sensor rows sensing the object.

9. The image reading device as defined in claim 1, further comprising a driving member for synchronously moving the light source, the sensor rows, and the rod lens row in a predetermined direction.

10. The image reading device as defined in claim 9, further comprising a control circuit electrically connected to the light source to control the light source to emit the color lights in a predetermined order and to change the color light when the light source, the sensor row, and the lens row are moved for a predetermined distance.

11. The image reading device as defined in claim 10, wherein the predetermined distance is identical to a width of a pixel.

12. A method of reading a color image, comprising the steps of:
A. putting an object at a predetermined place;
B. providing a light source to emit a first color light to the object that the object reflects the first color light to at least three monochromatic sensor rows to be directly imaged on the sensor rows, and reading signals of the sensor rows sensing the first color light;
C. synchronously moving the light source and the sensor rows in a predetermined direction;
D. changing the color light emitted from the light source to the object from the first color light to a second color light that object reflects the second color light to the sensor rows to be directly imaged on the sensor rows, and reading signals of the sensor rows sensing the second color light when the light source and the sensor rows are moved for a predetermined distance;
E. changing the color light emitted from the light source to the object from the second color light to a third color light that object reflects the third color light to the sensor rows to be directly imaged on the sensor rows, and reading signals of the sensor rows sensing the third color light when the light source and the sensor rows are further moved for the predetermined distance;
F. changing the color light emitted from the light source to the object from the third color light to the first color light that object reflects the first color light to the sensor rows to be directly imaged on the sensor rows, and reading signals of the sensor rows sensing the first color light when the light source and the sensor rows are further moved for the predetermined distance; and
G. repeating the step D to the step F until all of signals of the image of the object are read.

13. The method as defined in claim 12, wherein the first color light, the second color light, and the third color light are red light, green light, and blue light.

14. The method as defined in claim 12, wherein the first color light, the second color light, and the third color light are cyan light, magenta light, and yellow light.

15. The method as defined in claim 12, wherein the first color light, the second color light, and the third color light are imaged on the sensor rows by at least a lens row.

16. The method as defined in claim 12, wherein the predetermined distance is identical to a width of a pixel.

17. A method of reading a monochromatic image, comprising the steps of:
A. putting an object at a predetermined place;
B. providing a light source, which emit a plurality of color lights and the color lights are mixed into white light, to emit the white light to the object that the object reflects the white light to at least three monochromatic sensor rows to be directly imaged on the sensor rows, and reading signals of the sensor rows sensing the white light;
C. synchronously moving the light source and the sensor rows in a predetermined direction; and
D. repeating reading signals of the sensor rows sensing the white light every time when the light source and the sensor rows are moved for the predetermined distance until all of signals of the image of the object are read.

18. The method as defined in claim 17, wherein the predetermined distance is identical to a number of the sensor rows timing a width of a pixel.

19. The method as defined in claim 17, wherein the color lights emitted by the light source includes red light, green light, and blue light.

20. The method as defined in claim 17, wherein the color lights emitted by the light source includes cyan light, magenta light, and yellow light.
